(19) United States
(12) Patent Application Publication
(10) Pub. No.: US 2025/0303301 A1
(43) Pub. Date: Oct. 2, 2025

(54) INFORMATION PROCESSING APPARATUS AND GAME PLAY CONTROL METHOD

(71) Applicant: SONY INTERACTIVE ENTERTAINMENT INC., Tokyo (JP)

(72) Inventor: Tsuyoshi ONO, Tokyo (JP)

(73) Assignee: SONY INTERACTIVE ENTERTAINMENT INC., Tokyo (JP)

(21) Appl. No.: 18/995,869

(22) PCT Filed: Jul. 20, 2023
(86) PCT No.: PCT/JP2023/026527

§ 371 Date: Jan. 17, 2025

(30) Foreign Application Priority Data
Jul. 27, 2022 (JP) 2022-119321

(51) Int. Cl. A63F 13/73; A63F 13/44; A63F 13/533

(52) U.S. Cl. CPC A63F 13/73; A63F 13/44; A63F 13/533

(57) ABSTRACT

An execution section executes a game according to a user's operation input. At a timing for restricting a game play of a user, a restriction processing section restricts the game play of the user in principle. If, at the timing for restricting the game play of the user, the execution section is executing an activity for which a termination condition has been defined, the restriction processing section refrains from restricting the game play of the user.

### TECHNICAL FIELD

The present disclosure relates to a technology of controlling a user's game play.

### BACKGROUND ART

PTL 1 discloses a method for constructing a family group to which family members belong. Each member belonging to the family group is classified as an adult or a child by age. A family manager can determine the content of parental controls and make a change thereto, if needed. PTL 1 discloses, as items of the parental controls, an item for determining the upper limit of a game playable time period (permitted play time period) of a day for children, an item for determining a playable time slot of a day (a range of playable time) for children, an item for determining permission/prohibition of the use of a chat/message service with other users, etc.

### CITATION LIST

### Patent Literature

### PTL 1

PCT Patent Publication No. WO2019/021888

### SUMMARY

### Technical Problems

In a case where a permitted play time period of a day has been determined, a game apparatus restricts a game play of a child by, for example, forcibly terminating a game when a day's cumulative play time reaches the permitted play time period. Further, in a case where a playable time slot of a day has been determined, the game apparatus restricts a game play of a child at the end of the time slot. In such a manner, with the parental control function, the game apparatus forcibly restricts a game play of a child at a timing for restricting the game play of the child.

PTL 1 discloses giving a user a message indicating the remaining playable time at a timing when the remaining time reaches five minutes. However, in a situation where the user is in the middle of a match with another player or has just started a boss fight, it may be difficult to complete the play within five minutes. In such a situation, forced termination of the game is harsh to the user.

Therefore, an object of the present disclosure is to provide a technology of controlling a user's game play while flexibly implementing a parental control function.

### Solution to Problems

In order to solve the above problems, an information processing apparatus according to a certain aspect of the present disclosure includes an execution section that executes a game according to a user's operation input, and a restriction processing section that restricts a game play of a user at a timing for restricting the game play of the user. If an activity for which a termination condition has been defined is under execution by the execution section at the timing for restricting the game play of the user, the restriction processing section refrains from restricting the game play of the user.

A game play control method according to another aspect of the present disclosure includes executing a game according to a user's operation input, and refraining from restricting a game play of a user, if an activity of the game for which a termination condition has been defined is under execution at a timing for restricting the game play of the user.

Any combinations of the constituent elements described above and the expressions of the present disclosure that are converted between a method, an apparatus, a system, a recording medium, a computer program, and the like are also effective as aspects of the present disclosure.

### BRIEF DESCRIPTION OF DRAWINGS

FIG. 1 is a diagram depicting an information processing system according to an embodiment.

FIG. 2 is a diagram depicting a hardware configuration of an information processing apparatus.

FIG. 3 is a diagram depicting functional blocks of the information processing apparatus.

FIG. 4 is a diagram depicting one example of a parental control defining screen.

FIG. 5 is a diagram depicting one example of a game image.

FIG. 6 is a flowchart for implementing a parental control function.

FIG. 7 is a diagram indicating an example of a notification screen.

### DESCRIPTION OF EMBODIMENT

According to an embodiment, an information processing apparatus which is a user terminal apparatus executes game software. When an event occurs in a game, the game software outputs event information for identifying the occurring event to system software. An event occurs when a change occurs in a progress of a game play or a change occurs in a behavior of a game character, for example.

The game software includes a plurality of activities for which termination conditions have been defined. For each activity, it is preferable that a start condition be also defined. In this case, a progress of a game from establishment of the start condition to establishment of the termination condition constitutes one activity.

An activity refers to a play unit including a stage, a quest, a mission, a tournament, a session, etc., included in the game. An activity may be defined, as appropriate, by a game maker. For example, one quest that appears in a progress of the game may form one activity, or a plurality of quests may form one activity. In a case where a plurality of quests form one activity, a termination condition of the activity is that all of the plurality of quests are completed.

It is to be noted that the game maker may define all of stages, quests, missions, tournaments, and sessions included in the game as activities, and, alternatively, the game maker may define only part of the stages, the quests, the missions, the tournaments, and the sessions as activities. One activity may be defined for a set of a plurality of quests or missions, and may form one play unit, as previously explained.

When an activity is started, the game software outputs event information including an activity identifier (activity ID) for identifying the activity and information indicating the start of the activity to system software. When the activity is completed, the game software outputs event information including the activity ID and information indicating the completion of the activity to the system software. The system software generates event data by adding a user identifier (user account) for identifying a user, a game identifier (game ID) for identifying the game, and time information (time stamp) to the event information outputted from the game software, and transmits the event data to an external server apparatus.

The server apparatus may collect event data transmitted from a plurality of information processing apparatuses that are played by a plurality of players, and may analyze play tendencies relating to activities. For example, the server apparatus may statistically process activity play time periods of a plurality of players on the basis of event data transmitted from a plurality of information processing apparatuses.

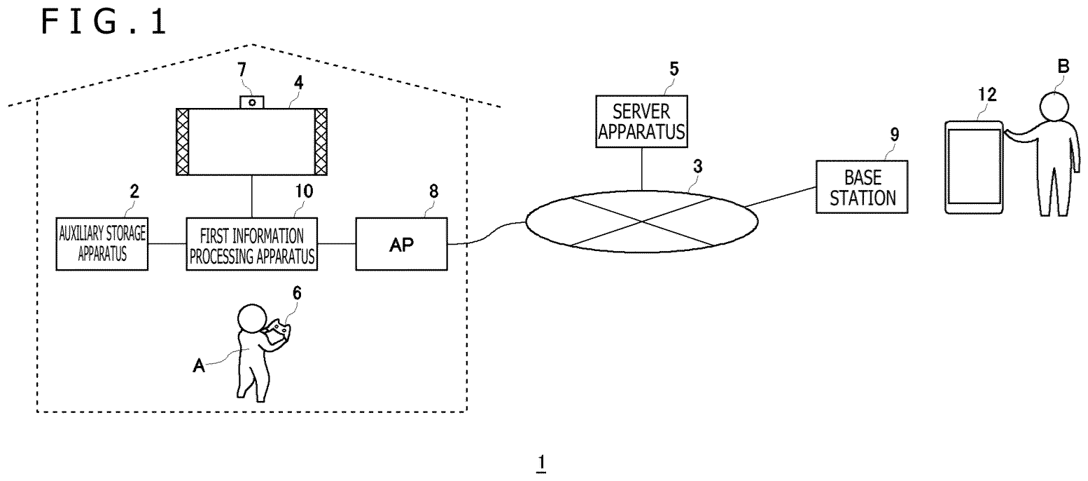

FIG. 1 depicts an information processing system 1 according to the embodiment of the present disclosure. The information processing system 1 includes a first information processing apparatus 10 that is used by a user A, a second information processing apparatus 12 that is used by a user B, and a server apparatus 5. An access point (hereinafter, referred to as an “AP”) 8 has a wireless access point function and a router function. By connecting to the AP 8 wirelessly or wiredly, the first information processing apparatus 10 establishes communicable connection with the server apparatus 5 and the second information processing apparatus 12 over a network 3.

The first information processing apparatus 10 is a game apparatus having a parental control function, and may be of a stationary type or a mobile type. According to the embodiment, the user A is a child to be subjected to parental controls while the user B is a parent of the user A and has an authority to define the parental control function.

The first information processing apparatus 10 is wirelessly or wiredly connected to an input apparatus 6 which is operated by the user A, and the input apparatus 6 outputs user A's operation information to the first information processing apparatus 10. Upon receiving the operation information from the input apparatus 6, the first information processing apparatus 10 reflects the operation information in a process in the system software or the game software, and causes an output apparatus 4 to output a result of the process. The input apparatus 6 is, for example, a game controller, and is configured to supply user A's operation information to the first information processing apparatus 10. It is to be noted that the input apparatus 6 may be an input interface such as a keyboard or a mouse.

The second information processing apparatus 12 may be a mobile terminal apparatus such as a mobile phone, a smartphone, or a tablet. By using the second information processing apparatus 12, the user B can remotely define or change the parental control function of the first information processing apparatus 10. It is to be noted that the user B is away from home in FIG. 1, but the user B can also define or change the parental control function of the first information processing apparatus 10 at home by directly operating the first information processing apparatus 10.

An auxiliary storage apparatus 2 is a large capacity storage apparatus such as an HDD (Hard Disk Drive) or an SSD (Solid State Drive), which may be a built-in storage apparatus, or may be an external storage apparatus that is connected to the first information processing apparatus 10 through a USB (Universal Serial Bus) or the like. The output apparatus 4 may be a television equipped with a display for outputting images and a loudspeaker for outputting sounds. The output apparatus 4 may be connected to the first information processing apparatus 10 via a wire cable, or may be connected to the first information processing apparatus 10 wirelessly.

A camera 7 which is an image capturing apparatus is set near the output apparatus 4, and captures an image of the space surrounding the output apparatus 4. FIG. 1 depicts an example in which the camera 7 is mounted on the upper portion of the output apparatus 4. Alternatively, the camera 7 may be disposed on a side portion or the lower portion of the output apparatus 4. In any case, the camera 7 is positioned to be capable of capturing an image of a user on the front side of the output apparatus 4. A stereo camera may be used as the camera 7.

The server apparatus 5 provides a network service to a user of the information processing system 1. The server apparatus 5 may physically include a plurality of servers, and each of the servers may be maintained and managed by entities according to respective functions. The server apparatus 5 manages network accounts for identifying respective users. By using a network account, a user signs-in to the server apparatus 5. After signing-in to the server apparatus 5, the users A and B can receive provision of a variety of services.

At a timing for restricting a game play of the user A, the first information processing apparatus 10 exerts the parental control function to forcibly terminate the game in principle. However, in a case where an activity is under execution at this timing, the first information processing apparatus 10 temporarily puts off forced termination of the game and allows the game play of the user A to be continued. At this time, instead of forcibly terminating the game, the first information processing apparatus 10 may give, to the server apparatus 5, a notification regarding information indicating that the game play of the user A is being continued, and the server apparatus 5 may send this information, via the base station 9, to the second information processing apparatus 12 of the user B who is a parent. When the activity is completed, the first information processing apparatus 10 forcibly terminates the game and restricts the game play of the user A.

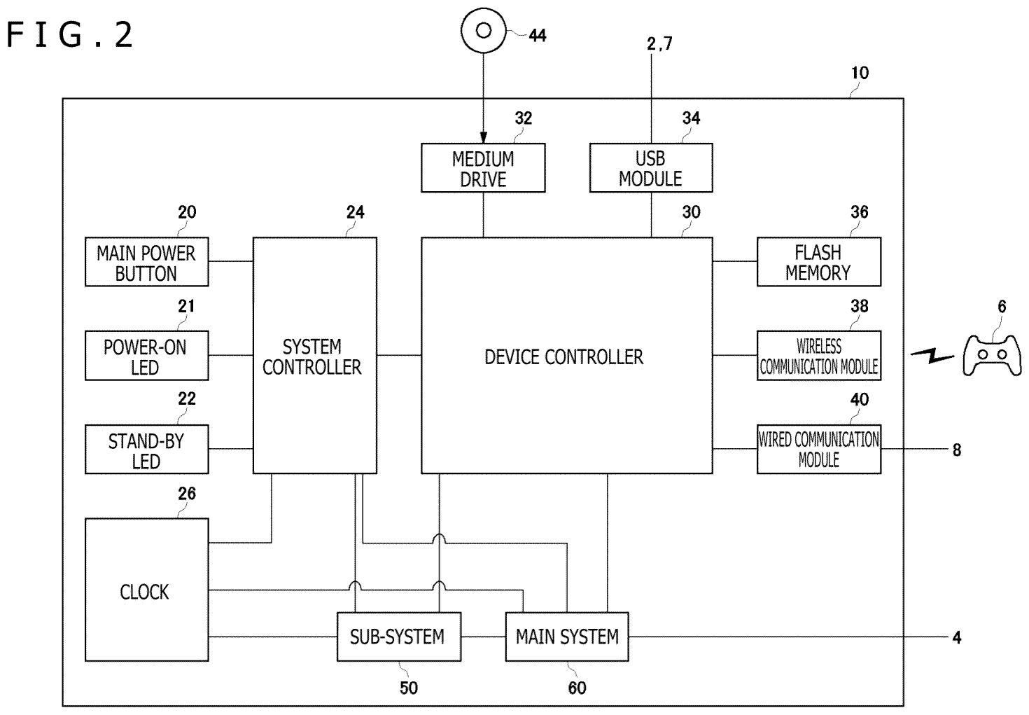

FIG. 2 depicts a hardware configuration of the first information processing apparatus 10. The first information processing apparatus 10 includes a main power button 20, a power-on LED (Light Emitting Diode) 21, a stand-by LED 22, a system controller 24, a clock 26, a device controller 30, a medium drive 32, a USB module 34, a flash memory 36, a wireless communication module 38, a wired communication module 40, a sub-system 50, and a main system 60.

The main system 60 includes a main CPU (Central Processing Unit), a memory which is a main storage device, a memory controller, a GPU (Graphics Processing Unit), etc. The GPU is mainly used for computing in a game program. These functions may be configured as a system on a chip, and thus, may be formed on one chip. The main CPU has a function of executing a game program recorded in the auxiliary storage apparatus 2.

The sub-system 50 includes a sub-CPU, a memory which is a main storage device, a memory controller, etc., but does not include a GPU or a function of executing a game program. The number of circuit gates in the sub-CPU is less than the number of circuit gates in the main CPU. The operation power consumption of the sub-CPU is smaller than the operation power consumption of the main CPU. The sub-CPU operates even if the main CPU is in a stand-by state. The processing function of the sub-CPU is restricted in order to minimize the power consumption.

The main power button 20 is an input section on which a user operation input is performed. The main power button 20 is disposed on a front surface of a casing of the first information processing apparatus 10, and is operated to turn ON/OFF a power source supply to the main system 60 of the first information processing apparatus 10. The power-on LED 21 is lit when the main power button 20 is ON. The stand-by LED 22 is lit when the main power button 20 is OFF.

The system controller 24 detects depression of the main power button 20 performed by the user. When the main power button 20 is depressed during an OFF state of a main power source, the system controller 24 acquires the depression operation as an “ON command.” On the other hand, when the main power button 20 is depressed during an ON state of the main power source, the system controller 24 acquires the depression operation as an “OFF command.”

The clock 26 which is a real-time clock generates current date/time information, and supplies the current date/time information to the system controller 24, the sub-system 50, and the main system 60. The device controller 30 is formed as an LSI (Large-Scale Integrated Circuit) that is like a south bridge to perform information exchange between devices. As depicted, such devices as the system controller 24, the medium drive 32, the USB module 34, the flash memory 36, the wireless communication module 38, the wired communication module 40, the sub-system 50, and the main system 60 are connected to the device controller 30. The device controller 30 absorbs differences in electric properties and data transfer speeds among the devices, and controls data transfer timings.

The medium drive 32 is a drive device that is driven with a ROM (Read Only Memory) medium 44, which has game software or the like and license information recorded therein, mounted on the drive device, and that reads out a program and data, for example, from the ROM medium 44. The ROM medium 44 is a read-only recording medium such as an optical disk, a magneto-optical disk, or a Blu-ray disc.

The USB module 34 is a module connected to an external apparatus via a USB cable. The USB module 34 may be connected to the auxiliary storage apparatus 2 and the camera 7 via USB cables. The flash memory 36 is an auxiliary storage device constituting an internal storage. The wireless communication module 38 performs wireless communication with the input apparatus 6 by using a communication protocol such as the Bluetooth (registered trademark) protocol or the IEEE (Institute of Electrical and Electronics Engineers) 802.11 protocol. The wired communication module 40 communicates with an external apparatus via a cable, and establishes connection with the network 3 via the AP 8.

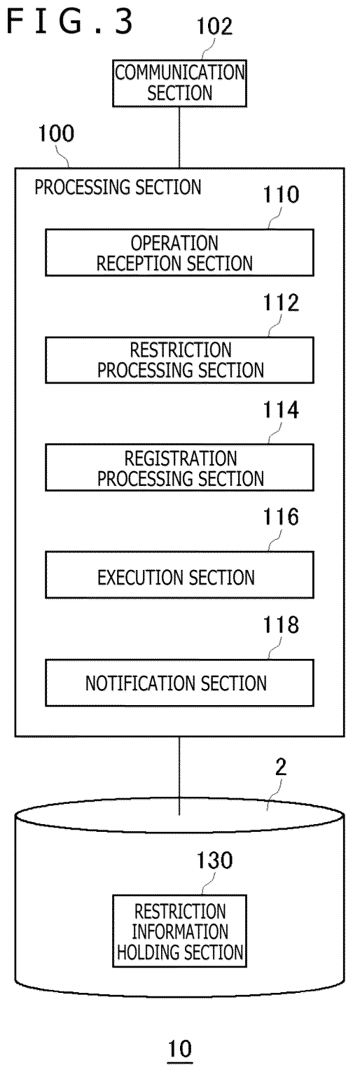

FIG. 3 depicts functional blocks of the first information processing apparatus 10. The first information processing apparatus 10 includes a processing section 100 and a communication section 102. The processing section 100 includes an operation reception section 110, a restriction processing section 112, a registration processing section 114, an execution section 116, and a notification section 118. The communication section 102 exhibits the functions of the wireless communication module 38 and the wired communication module 40 depicted in FIG. 2. The auxiliary storage apparatus 2 includes a restriction information holding section 130 that holds restriction information concerning parental controls.

The first information processing apparatus 10 includes a computer. The computer executes a program to implement the various functions depicted in FIG. 3. The computer includes, as hardware, a memory for loading a program, one or more processors for executing a loaded program, an auxiliary storage, any other LSI, and the like. The processor (Each of the processors) may be formed of a plurality of electronic circuits including a semiconductor integrated circuit and an LSI. The plurality of electronic circuits may be mounted on one chip, or may be mounted on a plurality of chips. The functional blocks depicted in FIG. 3 are implemented by cooperation of hardware and software, and thus, a person skilled in the art will understand that these functional blocks can be implemented in many different ways by hardware only, by software only, or by a combination of the two.

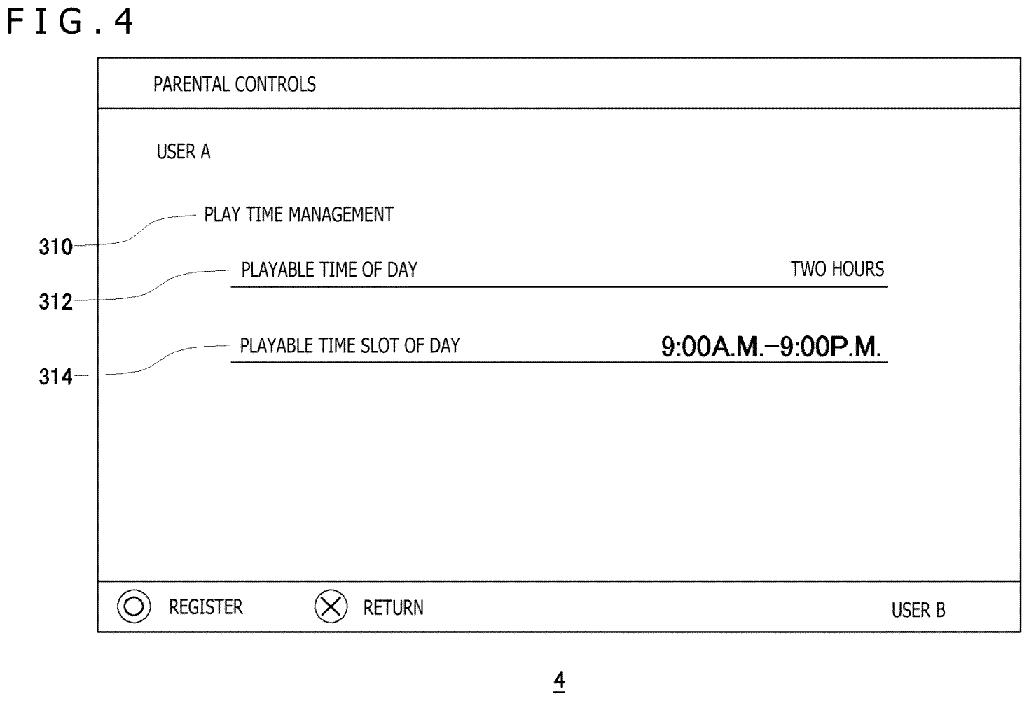

FIG. 4 depicts one example of a parental control defining screen. Here, FIG. 4 depicts an example in which the user B defines restriction information concerning parental controls through the first information processing apparatus 10. However, restriction information concerning parental controls can also be defined through the second information processing apparatus 12.

On a parental control defining screen, a play time management area 310 is an area for defining information for managing a child's game play. A play time defining item 312 is an item for defining the upper limit (permitted play time period) for a child of a day. The permitted play time period is defined as a cumulative time including not only a play time period on the first information processing apparatus 10 but also a play time period on another information processing apparatus. In the example depicted in FIG. 4, a period of “two hours” is defined in the play time defining item 312. This indicates that the permitted play time period of a day for the user A is a period of “two hours.” For example, it is assumed that the user A plays a game on an information processing apparatus in a friend's house for one hour and then goes back home and plays a game on the first information processing apparatus 10 for one hour. In this case, the restriction processing section 112 determines that the play time of the user A reaches two hours which is the upper limit. It is to be noted that the cumulative play time of the user A may be measured by the server apparatus 5, and the server apparatus 5 may determine that the play time reaches two hours.

A play period defining item 314 is an item for defining a play time slot for a child of a day. The play time slot represents a range within which the user A is allowed to play in a day. In the example in FIG. 4, the play time slot is defined to be the hours of 9 A.M. to 9 P.M. This indicates that the user A is not allowed to play a game from 9 P.M. to 9 A.M. It is to be noted that the item values of the play time defining item 312 and the play period defining item 314 may be defined for each day of the week.

The user B inputs the item values of the play time defining item 312 and the play period defining item 314, and operates a predetermined button (e.g., “o” button) on the input apparatus 6. Then, the registration processing section 114 registers, as restriction information concerning parental controls, the item values defined on the parental control defining screen into the restriction information holding section 130. By opening the parental control defining screen on the first information processing apparatus 10 or the second information processing apparatus 12, the user B can update the restriction information at any time. It is to be noted that any item of parental controls other than the play time management may be provided on the parental control defining screen.

Described with reference to FIG. 3 again, the operation reception section 110 receives a user A's operation input performed on the input apparatus 6, via the communication section 102. The execution section 116 executes a game according to the user's operation input. Specifically, the execution section 116 executes a game program to generate a game image and a game sound and output the game image and the game sound through the output apparatus 4. A function exhibited by the execution section 116 is implemented by, for example, such hardware as a GPU to execute system software, the game program, and rendering processing.

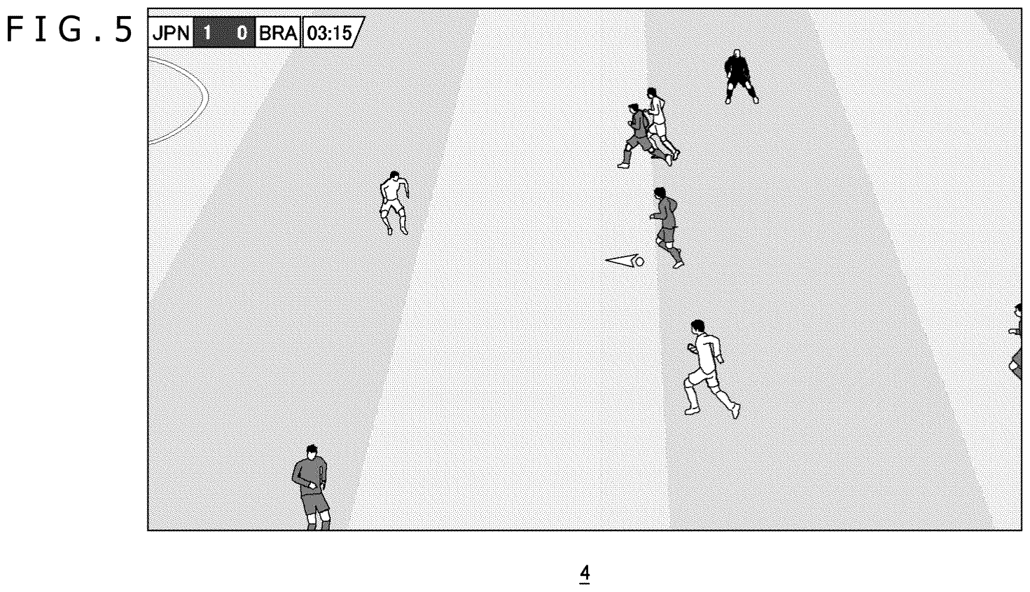

FIG. 5 depicts one example of a game image displayed on the output apparatus 4. The execution section 116 executes a game according to a user A's operation input, and outputs a game image and a game sound through the output apparatus 4. In the embodiment, for the user A who is a child, a period of “two hours” is defined as the permitted play time period of a day, and further, “9:00 A.M. to 9:00 P.M.” is defined as the play time slot of a day.

The restriction processing section 112 measures a time period (play time period) during which the user A has played a game on a day. The server apparatus 5 regularly acquires the play time period of the user A measured by the restriction processing section 112. Accordingly, a cumulative play time of the user A is synchronized between the first information processing apparatus 10 and the server apparatus 5. It is to be noted that, if the user A has already played on the day, the server apparatus 5 transmits the present cumulative play time of the day to the first information processing apparatus 10 at a start time of a game play of the user A. The current cumulative play time of the day represents a time period obtained by, for example, in a case where the user has played a game on the first information processing apparatus 10 or on an information processing apparatus in a friend's house before the current game play, cumulating (totalizing) the play time periods of this case. Accordingly, the restriction processing section 112 can check the cumulative play time of the user A of the day. When the cumulative play time of the user A reaches a permitted play time period (two hours), the restriction processing section 112 determines that a timing for restricting the game play of the user A has come.

Further, the restriction processing section 112 monitors whether or not the current clock time at which the user A is playing a game is included in the permitted play time slot. When the current clock time at which the user A is playing a game reaches 9:00 P.M., the restriction processing section 112 determines that a timing for restricting the game play of the user A has come.

After determining that the timing for restricting the game play of the user A has come, the restriction processing section 112 restricts the game play of the user A in principle. The restriction processing section 112 may restrict the game play of the user A by forcibly terminating the game program being executed by the execution section 116, or may restrict the game play of the user A in a different way.

In the embodiment, at the timing for restricting the game play of the user, the restriction processing section 112 temporarily puts off forced termination of the game and refrains from restricting the game play of the user if the execution section 116 is executing an activity. As previously explained, an activity refers to a play unit including a stage, a quest, a mission, a tournament, a session, etc., included in the game. For each play unit, a termination condition is defined. Thereafter, when receiving provision of information indicating that the activity is completed from the game, the restriction processing section 112 may forcibly terminate the game and restrict the game play of the user A.

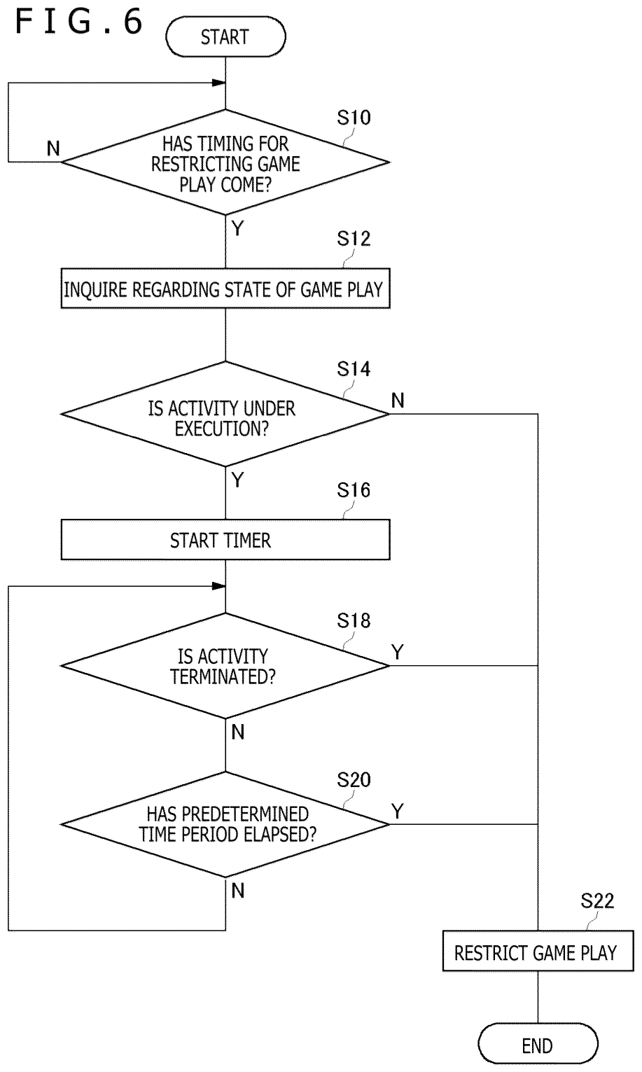

FIG. 6 is a flowchart for implementing the parental control function according to the embodiment. The restriction processing section 112 monitors whether or not a timing for restricting a game play of the user A has come (S10). When the cumulative play time of the user A of the day is less than the permitted play time period (two hours) of a day, the restriction processing section 112 determines that the timing for restricting the game play of the user A has not yet come (N at S10). On the other hand, when the cumulative play time of the user A of the day reaches the permitted play time period, the restriction processing section 112 determines that the timing for restricting the game play of the user A has come (Y at S10). Also, when the current clock time at which the user A is playing the game reaches 9:00 P.M. which is the end of the permitted play time slot, the restriction processing section 112 determines that the timing for restricting the game play of the user A has come (Y at S10). It is to be noted that, alternatively, the server apparatus 5 may monitor whether or not the timing for restricting the game play of the user A has come and report the monitoring result to the restriction processing section 112.

When the timing for restricting the game play of the user A has come (Y at S10), the restriction processing section 112 inquires of the game regarding the state of the game play of the user A (S12). For example, the restriction processing section 112 may inquire of the game regarding, as the state of the game play of the user A, whether or not the game play is allowed to be forcibly terminated. Here, a state in which the game play is allowed to be forcibly terminated refers to a state in which no activity is under execution. A state in which the game play is not allowed to be forcibly terminated refers to a state in which an activity is under execution.

In response to the inquiry, the game provides the current state of the game play to the restriction processing section 112. In a case where the state of the game play provided from the game indicates that an activity is under execution (Y at S14), the restriction processing section 112 refrains from restricting the game play of the user A and allows continuation of the game play of the user A. Accordingly, the user A does not need to interrupt the activity and can continue the activity. On the other hand, when the state of the game play provided from the game indicates that no activity is under execution (N at S14), the restriction processing section 112 restricts the game play of the user A (S22) and exerts parental controls.

After deciding to refrain from restricting the game play, the restriction processing section 112 starts a timer to measure the length of time elapsed from the timing for restricting the game play (S16). If a predetermined time period has not yet elapsed from the start of the timer (N at S20), the restriction processing section 112 waits for provision of information indicating completion of the activity from the game. After receiving provision of information indicating completion of the activity from the game (Y at S18) during the measurement using the timer, the restriction processing section 112 does not need to allow continuation of the game play of the user A any more. Therefore, the restriction processing section 112 forcibly terminates the game and restricts the game play of the user A (S22). It is to be noted that the information indicating completion of the activity may be event information including information indicating completion of the activity.

When information indicating completion of the activity is not provided from the game (N at S18) but the measured time reaches the predetermined time period (Y at S20), the restriction processing section 112 forcibly terminates the game and restricts the game play of the user A (S22). A termination condition is defined for each activity, but some activities take a long period of time before establishment of its termination condition. For this reason, when the predetermined time period elapses from the timing for restricting the game play of the user A, the restriction processing section 112 may restrict the game play of the user A and exert parental controls. For example, the predetermined time period may be set to 10 to 20 minutes.

It is to be noted that, even if an activity is under execution at S14, the restriction processing section 112 may operate to restrict the game play depending on the type of the activity. In a case where the state of the game play provided from the game indicates that an activity of a first type is under execution, the restriction processing section 112 may refrain from restricting the game play of the user A. In a case where the state of the game play provided from the game indicates that an activity of a second type is under execution, the restriction processing section 112 may restrict the game play of the user A. For example, an activity of the first type is an activity that takes a relatively short period of time to establish its termination condition, and an activity of the second type is an activity that takes a relatively longer period of time to establish its termination condition than the activity of the first type.

The first information processing apparatus 10 may hold, in the auxiliary storage apparatus 2, a database in which a list of types of activities belonging to the first type and a list of types of activities belonging to the second type are recorded. When providing information indicating that an activity is under execution to the restriction processing section 112 at S14, the game additionally provides the type of the activity under execution to the restriction processing section 112. The restriction processing section 112 may determine, with reference to the database, which of the first type and the second type the activity belongs to, on the basis of the provided type of the activity, and may decide whether or not to restrict the game play, according to the determined type.

It is to be noted that the explanation of this example in which the restriction processing section 112 decides whether or not to restrict the game play on the basis of the type of an activity under execution has been given, but, alternatively, the game may determine to continue the activity or forcibly terminate the activity, and provide a result of the determination to the restriction processing section 112.

In a case where the restriction processing section 112 has decided to refrain from restricting the game play of the user A (Y at S14), the notification section 118 may notify the parent (user B) of the user of the fact that the game play of the user A would not be restricted. Specifically, the notification section 118 transmits information indicating that the game play of the user A is decided to be continued and information regarding the activity being played, to the server apparatus 5 via the communication section 102, and then, the server apparatus 5 transmits the information to the second information processing apparatus 12 of the user B.

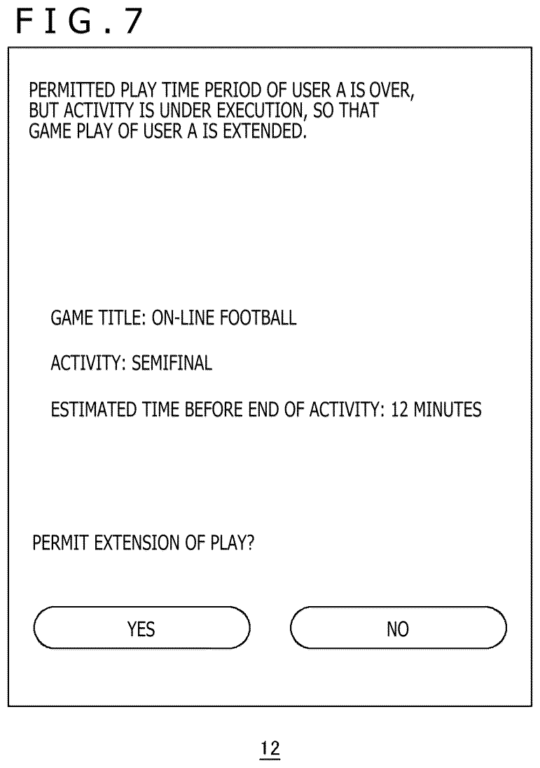

FIG. 7 depicts an example of a notification screen that is displayed on the second information processing apparatus 12 of the user B. A state in which a game play of the user A is prolonged as well as a game title and the name of an activity being currently played by the user A are indicated on the notification screen. It is to be noted that, if estimated time that will be taken to complete the activity is derived, the estimated time that will be taken to the completion may be indicated. On the basis of these kinds of the information, the user B makes a selection to permit/prohibit prolongation of the game play of the user A.

If the user B selects “NO” on the notification screen, the second information processing apparatus 12 gives a command to restrict the game play of the user A to the first information processing apparatus 10 via the server apparatus 5. Upon receiving the command to restrict the game play from the parent (user B) of the user A, the restriction processing section 112 may immediately restrict the game play of the user A.

The present disclosure has been explained so far on the basis of the embodiment. The embodiment exemplifies the present disclosure, and a person skilled in the art will understand that various modifications can be made to a combination of the constituent elements or the process steps of the embodiment and that these modifications are also within the scope of the present disclosure. The first information processing apparatus 10 of the embodiment is a stationary game machine, but the first information processing apparatus 10 may be a cloud server that provides a cloud gaming service to the user A.

### INDUSTRIAL APPLICABILITY

The present disclosure can be used in the technical field for controlling game plays of users.

### REFERENCE SIGNS LIST

1: Information processing system
5: Server apparatus
10: First information processing apparatus
12: Second information processing apparatus
100: Processing section
102: Communication section
110: Operation reception section
112: Restriction processing section
114: Registration processing section
116: Execution section
118: Notification section
130: Restriction information holding section

1. An information processing apparatus comprising: processing circuitry configured to
execute a game according to operation input of a user;
determine that a time limit for restricting the game has been satisfied;
after determination that the time limit has been satisfied, refrain from restricting a game play of the user in a case that an activity of the game being executed; and
restrict the game play of the user.

2. The information processing apparatus according to claim 1, wherein after the determination that the time limit has been satisfied, the processing circuitry is further configured to check a state of the game play of the user.

3. The information processing apparatus according to claim 2, wherein
in a case that the state of the game play indicates that the activity is being executed, the at processing circuitry refrains from restricting the game play of the user, and
in a case that the state of the game play indicates that no activity is under execution, the processing circuitry restricts the game play of the user.

4. The information processing apparatus according to claim 2, wherein
in a case that the state of the game play indicates that the game play is not allowed to be forcibly terminated, the processing circuitry refrains from restricting the game play of the user, and
in a case that the state of the game play indicates that the game play is allowed to be forcibly terminated, the processing circuitry restricts the game play of the user.

5. The information processing apparatus according to claim 2, wherein
in a case that the state of the game play indicates that the activity is of a first type and the activity is under execution, the processing circuitry refrains from restricting the game play of the user, and
in a case that the state of the game play indicates that the activity is of a second type and the activity is under execution, the processing circuitry restricts the game play of the user.

6. The information processing apparatus according to claim 1, wherein when receiving provision of information indicating that the activity is completed from the game, the processing circuitry restricts the game play of the user.

7. The information processing apparatus according to claim 1, wherein processing circuitry is further configured to notify a parent of the user of a decision to refrain from restricting the game play of the user.

8. The information processing apparatus according to claim 7, wherein when receiving a command to restrict the game play from the parent of the user, the processing circuitry restricts the game play of the user.

9. The information processing apparatus according to claim 1, wherein after a predetermined time period elapses from the time limit being satisfied, the processing circuitry restricts the game play of the user.

10. A game play control method, comprising:
executing a game according to an operation input of a user;
determining that a time limit for restricting the game has been satisfied;
after the determining that the time limit has been satisfied, refraining from restricting a game play of the user in a case that an activity of the game is being executed; and
restricting the game play of the user.

11. (canceled)

12. The method according to claim 10, further comprising:
after the determining that the time limit has been satisfied, checking a state of the game play of the user.

13. The method according to claim 12, further comprising:
in a case that the state of the game play indicates that the activity is being executed, refraining from restricting the game play of the user; and
in a case that the state of the game play indicates that no activity is under execution, restricting the game play of the user.

14. The method according to claim 12, further comprising:
in a case that the state of the game play indicates that the game play is not allowed to be forcibly terminated, refraining from restricting the game play of the user; and
in a case that the state of the game play indicates that the game play is allowed to be forcibly terminated, restricting the game play of the user.

15. The method according to claim 12, further comprising:
in a case that the state of the game play indicates that the activity is of a first type and the activity is under execution, refraining from restricting the game play of the user; and
in a case that the state of the game play indicates that the activity is of a second type and the activity is under execution, restricting the game play of the user.

16. The method according to claim 10, further comprising:
when receiving provision of information indicating that the activity is completed from the game, restricting the game play of the user.

17. The method according to claim 10, further comprising:
notifying a parent of the user of a decision to refrain from restricting the game play of the user.

18. The method according to claim 17, further comprising:
when receiving a command to restrict the game play from the parent of the user, restricting the game play of the user.

19. The method according to claim 10, further comprising:
after a predetermined time period elapses from the time limit being satisfied, restricting the game play of the user.

20. A non-transitory computer readable medium storing computer executable instructions which, when executed by processing circuitry, cause the processing circuitry to execute a process comprising:
executing a game according to an operation input o fa user;
determining that a time limit for restricting the game has been satisfied;
after the determining that the time limit has been satisfied, refraining from restricting a game play of the user in a case that an activity of the game is being executed; and
restricting the game play of the user.

21. the non-transitory computer readable medium according to claim 20, wherein the process further comprises after the determining that the time limit has been satisfied, checking a state of the game play of the user.
